(19) United States
(12) Patent Application Publication
(10) Pub. No.: US 2003/0156192 A1
(43) Pub. Date: Aug. 21, 2003

(54) Mobile video security system

(76) Inventor: Yong Min Cho, Silver Spring, MD (US)

Correspondence Address: Mr. Yong Min Cho, 16605 Sea Island Court, Silver Spring, MD, 20905, US

(21) Appl. No.: 10/078,435

(22) Filed: Feb. 21, 2002

(51) Int. Cl. H04N 7/18

(52) U.S. Cl. 348/143

(57) ABSTRACT

When security personnel is patrolling at the airports, shopping malls or office buildings, the video images of the surveillance video cameras are most valuable and important information that they can use. Using wireless network with hand held personal computer, the mobile video security system is the most efficient way of maintaining a security in buildings, shopping malls and airports.

### BACKGROUND OF THE INVENTION

The mobile video security system is an efficient way of maintaining a security in buildings, shopping malls and airports. The mobile video security system is wireless networked to central security monitoring system. All of security personnel carry a wireless hand held personal computer to communicate with central video security monitoring system. Through the wireless network, all of security personnel are capable to receive video images and also communicate each other.

### SUMMARY OF THE INVENTION

The primary objective of this invention is to provide video images to security personnel who are patrolling the areas. The hand held mobile video security system is capable to communicate with central video security monitoring system with voice, data and video images through wireless network. It will give great strength and advantages to security personnel to understand the situations and ability to manage the cases and do their job.

### BRIEF DESCRIPTION OF THE DRAWING

This invention can be fully understood through references to the following one figure and its brief description below:

FIG. 1 is a conceptual system view of the mobile video security system.

### DETAILED DESCRIPTION OF THE DRAWING

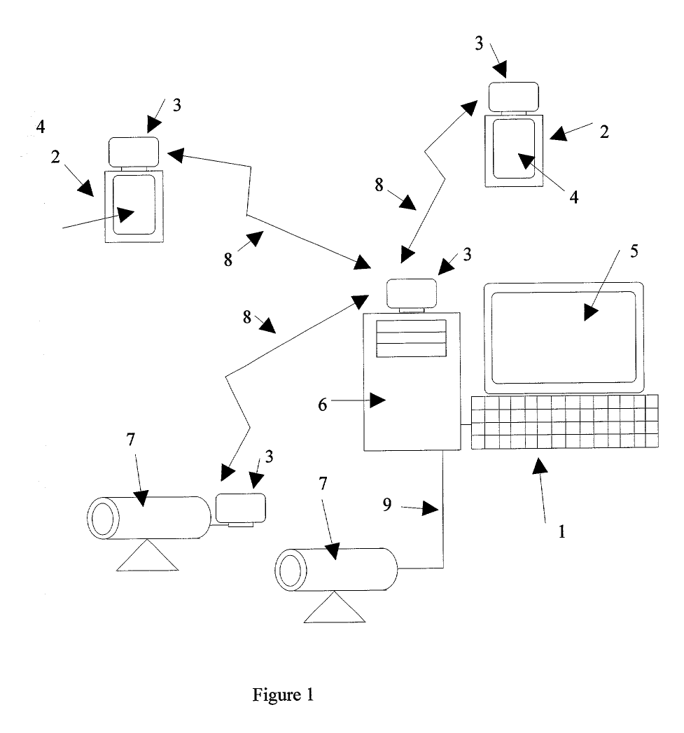

In FIG. 1, the central video security monitoring system 1 is connected and networked with hand held personal computer 2 through wireless link 8 using wireless transceiver 3. The server 6 of the central video security monitoring system 1 is also connected to surveillance video cameras 7 through wireless link 8 or through the wire 9. The hand held personal computer 2 is capable to display the selected video on its screen 4 from the displayed video 5 of the central video security monitoring system 1.

I claimed:

1. A mobile video security system that is using hand held personal computer to communicate with central video security monitoring system through wireless network.

2. A mobile video security system that is using hand held personal computers as remote video security monitors through wireless network.
